(19) United States
(12) Patent Application Publication
(10) Pub. No.: US 2003/0145048 A1
(43) Pub. Date: Jul. 31, 2003

(54) System and method for HTTP request preprocessing for servlets and application servers

(75) Inventors: Srinagesh Susarla, Fremont, CA (US); Ruslan Bilorusets, Oakland, CA (US)

Correspondence Address: Sheldon R. Meyer, FLIESLER DUBB MEYER & LOVEJOY LLP, Fourth Floor, Four Embarcadero Center, San Frncisco, CA, 94111-4156, US

(73) Assignee: BEA Systems, Inc., San Jose, CA

(21) Appl. No.: 10/345,781

(22) Filed: Jan. 16, 2003

Related U.S. Application Data
(60) Provisional application No. 60/349,584, filed on Jan. 18, 2002.

(51) Int. Cl. G06F 15/16

(52) U.S. Cl. 709/203; 709/245

(57) ABSTRACT

The invention provides a system and method for providing http request preprocessing for servlets. Preprocessors are server-side components designed to handle HTTP requests, and are primarily targeted for use with Web applications written according to the J2EE Servlets and JSP specifications. To do this, the invention provides an architecture for the support of preprocessing HTTP requests. During request processing, the preprocessor components gain control before J2EE servlets are invoked. The preprocessors can thus influence the behavior of the servlet engine by participating in targeting the request to a servlet.

### CLAIM OF PRIORITY

This application claims priority from provisional application “SYSTEM AND METHOD FOR HTTP REQUEST PREPROCESSING FOR SERVLETS AND APPLICATION SERVERS” Application No. 60/349,584 filed Jan. 18, 2002, and which application is incorporated herein by reference.

### FIELD OF THE INVENTION

The invention relates generally to application servers and particularly to a system and method for providing http request preprocessing for servlets.

### BACKGROUND

An ever-increasing number of e-commerce providers or e-businesses rely on application server technology as the lifeblood of their business. Application servers form a proven foundation for supporting e-commerce applications, providing the presentation, business and information-access logic, security and management services, and underlying infrastructure required for highly scalable and mission-critical software applications. Increasingly, the demands of today's modern businesses require support for a new breed of Web and wireless applications, helping to meet the needs of increasingly sophisticated customers.

One such application server, WebLogic Server, from BEA Systems, Inc. San Jose, Calif., is based on an implementation of the Java 2 Enterprise Edition (J2EE) specification. WebLogic Server is used as the backbone for many of today's most sophisticated e-business applications, playing an integral role in a tightly integrated, comprehensive infrastructure that delivers commerce, personalization, campaign management, enterprise integration, workflow management, and business-to-business collaboration. From Web and wireless clients to Windows, Unix, and mainframe servers, WebLogic Server manages all of the underlying complexities of a business' e-commerce applications, allowing the organization to focus instead on delivering new and innovative products and services.

A typical application server, including WebLogic Server, supports a variety of clients, including Web browsers, and wireless devices. On the server side, WebLogic Server supports leading Unix, Linux, Windows, and mainframe operating systems. On the back-end, WebLogic Server integrates with relational databases, messages queues, and legacy systems. WebLogic Server provides support for features such as Servlets, Java Server Pages (JSPs), Enterprise JavaBeans (EJBs), Java Messaging Service (JMS), to provide access to standard network protocols, database, and messaging systems. When developing applications, developers can create, assemble, and deploy components that use these services.

In a typical deployment, WebLogic Server also includes a Web server for hosting static content and dynamic J2EE Web applications. J2EE Web applications typically include a collection of HTML/XML pages, Java Server Pages, Servlets, Java classes, applets, images, multimedia files, and other file types. WebLogic Server may also be integrated with other Web servers such as Apache, Microsoft IIS, or Netscape Web servers. Web components usually provide the presentation logic for browser-based or wireless applications, while EJB components encapsulate business objects and processes. The purpose of this feature is to allow the preprocessors influence the behavior of the servlet engine by participating in targeting the request to a servlet, setting the request attributes, etc.

The standard JSP Model 2 architecture, in which a servlet handles the initial request from the user, and then invokes a JSP to generate the response, has become a standard method in developing Web applications. It's main purpose is to separate the presentation logic from the underlying business logic. However, this approach does not work in some cases. For instance, by the time the controlling servlet is chosen, the user is already authenticated, and the HTTP session is identified, etc. In the cases of wireless applications and sophisticated WebFlow mechanisms, the WebFlow controller is not able to participate in these initial processes. A method that allows the web server to take a more active role in the initial stages of processing an HTTP request would provide more flexibility, and would allow the system to handle a greater variety of user devices, and would allow for more complex routing and processing of the request.

### SUMMARY

The invention solves the need for a more flexible http request processing by allowing request preprocessors to be plugged in to the Web server. Preprocessors are server side components designed to handle HTTP requests only., and are primarily targeted for use with Web applications written according to the J2EE Servlets and JSP specifications. To do this, the invention provides an architecture for the support of preprocessing HTTP requests. During request processing, the preprocessor components gain control before J2EE servlets are invoked. The preprocessors can thus influence the behavior of the servlet engine by participating in targeting the request to a servlet, setting the request attributes, etc.

The HTTP request preprocessor infrastructure can also be used to customize the servlet engine of a web server product such as Weblogic Server. It allows for natural integration of complex features like WebFlow and Wireless solutions.

In one embodiment the invention comprises a system for using preprocessors to respond to uniform resource indicator requests in application servers, comprising:a web server component for receiving uniform resource indicator requests and passing said requests to the application server; a preprocessor for modifying said requests before communicating them to a destination resource; and, a configuration file for specifying a particular preprocessor to be mapped to said uniform resource indicator request.

In another embodiment the invention comprises a method of using virtual directories to respond to uniform resource indicator requests in application servers, comprising the steps of: receiving uniform resource indicator requests at a web server component for communication to the application server; identifying using a configuration file a preprocessor to be used; communicating said request to a preprocessor for communication to a destination resource; and, modifying said requests before communicating them to the destination resource.

### BRIEF DESCRIPTION OF THE DRAWINGS

FIG. 1 shows a plan of a typical browser/application server interaction.

FIG. 2 shows a plan of a preprocessor capable web server in accordance with an embodiment of the invention.

FIG. 3 shows a flowchart of a method for preprocessing an http request in accordance with an embodiment of the invention.

FIG. 4 shows an overview of a system that includes preprocessor support for a variety of user access device types in accordance with an embodiment of the invention.

FIG. 5 shows a flowchart of a method for providing preprocessor support for a variety of user access device types in accordance with an embodiment of the invention.

### DETAILED DESCRIPTION

Generally described, the invention provides a system and method for providing http request preprocessing for servlets. Preprocessors are server side components designed to handle HTTP requests only, and are primarily targeted for use with Web applications written according to the J2EE Servlets and JSP specifications. To do this, the invention provides an architecture for the support of preprocessing HTTP requests. During request processing, the preprocessor components gain control before J2EE servlets are invoked. The preprocessors can thus influence the behavior of the servlet engine by participating in targeting the request to a servlet.

For example, the logic for determining the device can be built into the preprocessor which then returns the URI for the specific device, as illustrated by the following steps:

Preprocessor “foo” is mapped to “/foo/*”

Request comes in with URI:“/foo/foo.html”

preservice() of preprocessor is called: if (device.MOBILE) {return “/mobile/foo.whtml”; else if (device.PDA) {return “/pda/foo.chtml”; } . . .

The returned URI is then used to dispatch the request.

Definitions of Terms, Acronyms, and Abbreviations

ECA—E-Commerce Applications. BEA's Business Unit where Commerce and Personalization Servers are developed.

J2EE—Java 2 Enterprise Edition. A number of Java specs available from Sun.

WebFlow—Servlet framework used to separate the flow on the web site from the rest of web application logic. Initially developed at ECA; now, in the process of being integrated in WLS.

WLS—WebLogic Server.

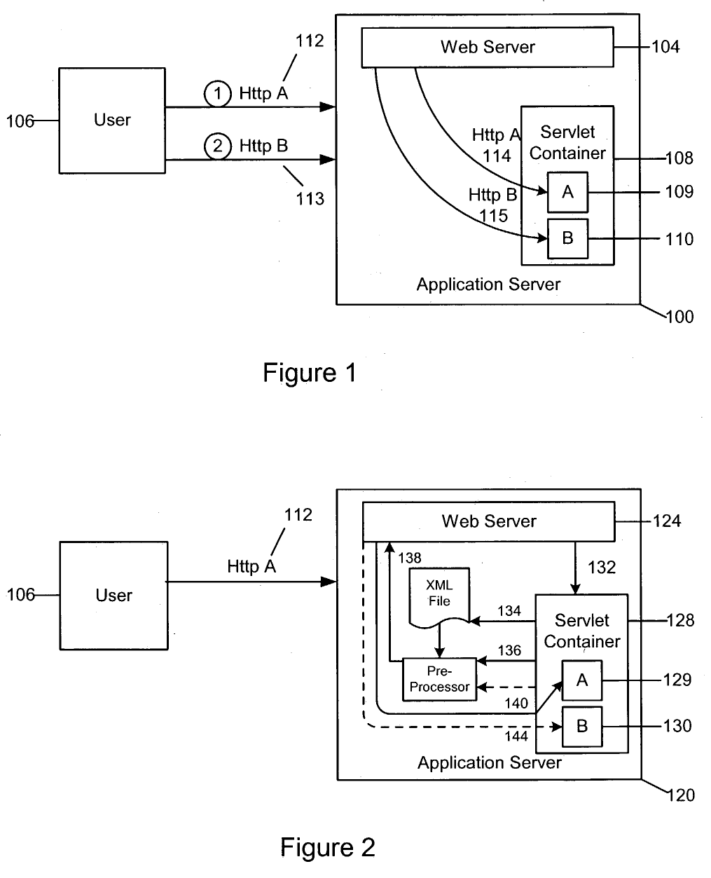

FIG. 1 shows a plan of a typical browser/application server interaction. As shown in FIG. 1, a user 106 operating a browser, WAP devices, or some other type of Web device, interacts with an application server 100 that includes a Web server component 104. Typically this access is by means of an http request 112 to the Web server. The http request is interpreted by the Web server, and passed 114, to the servlet container 108 for communication to a corresponding servlet 109. Subsequent access 113 may be to the same servlet or application, or it may be to different servlet 110 (webapp 1, webapp 2, etc.). While the resource shown in FIG. 1 is a servlet, it will be evident that other resources, including graphical images may be requested as part of the http request.

FIG. 2 shows a plan of a preprocessor-capable web server in accordance with the invention. As before, a user 106 operating a browser, WAP devices, or some other type of Web device, interacts with an applications server 120 that includes a Web server component 124. Again, this access is by means of an http request 112 to the Web server. However, in accordance with an embodiment of the invention, the application server (and hence the web server) includes a means for preprocessing this request. As shown in FIG. 2, the Web server passes 124 the request to the servlet container 128 for processing. The servlet container determines 134, using an XML configuration file, any preprocessor associated with this request pattern, and then calls that preprocessor 136. The URL pattern matching mechanism is the same as used in the HTTP request resolution. Based on the result of the preprocessor as reported 138 to the Web server, the servlet access may be to a first servlet 129, or it may be to different servlet 130 From the user's perspective the end result is the same, but from an administrative point of view, the preprocessor is easier to manage, and provides an easy pluggable method of adding support for new request patterns and user types. It also avoids duplicate security checks on resources, since the destination URI or resource is different from the URI that first comes into the server.

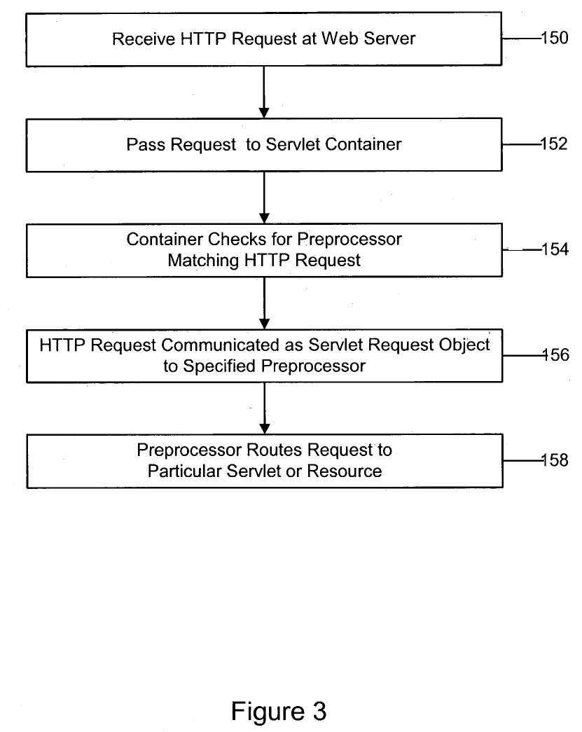

FIG. 3 shows a flowchart of a method for preprocessing an http request in accordance with the invention. In step 150 the system receives an HTTP request at the Web Server. In step 152 this request is passed to the servlet container. The container, in step 154, checks for a preprocessor matching the HTTP request. In step 156 the HTTP request is communicated as a servlet request object to the specified preprocessor, and in step 158 the preprocessor routes the request to a particular servlet or other resource.

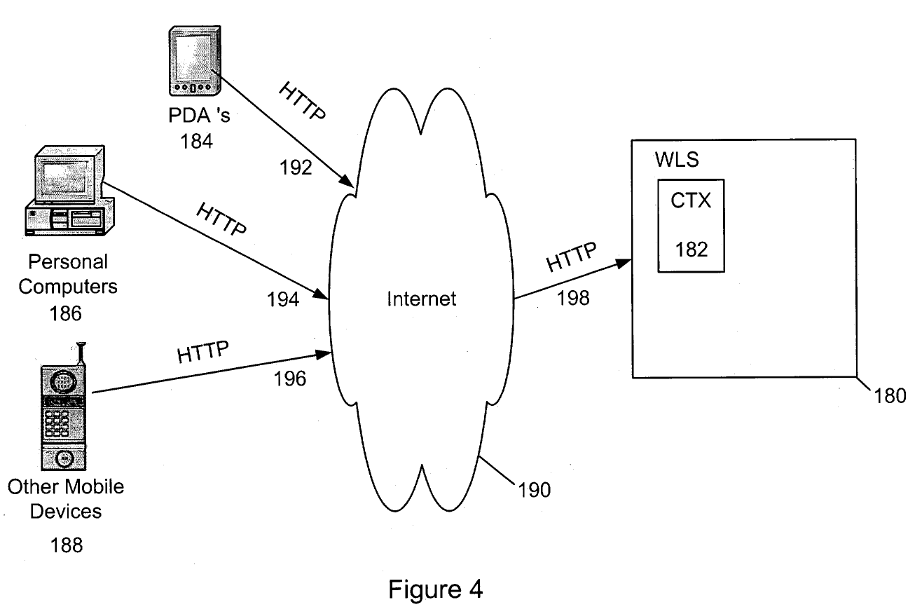

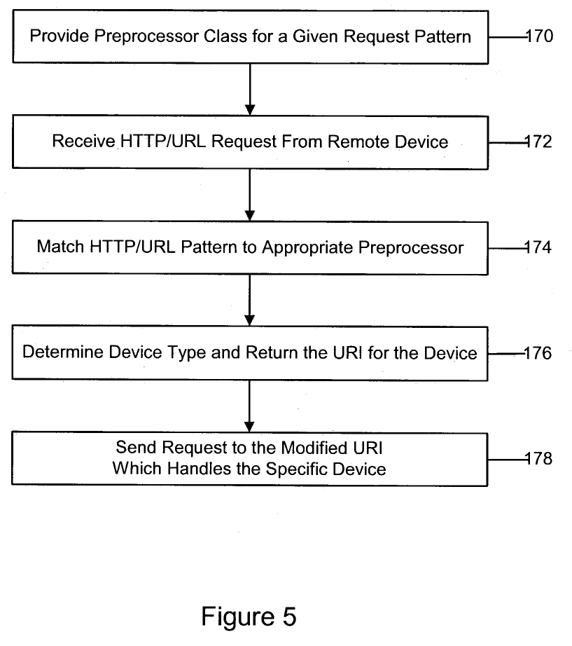

FIG. 4 illustrates how the request/response feature can be used in a pervasive computing environment. As shown in FIG. 4, the application server 180 includes a preprocessor framework (described in detail in FIG. 5), in-built into the Servlet Container which allows many different types of device, including for example PDA's 184, personal computers 186, cellular telephones, and other mobile devices 188, to readily connect to the application server via the Internet 190. In FIG. 4, the CTX 182 represents the web application (context) deployed on the server with a preprocessor installed. As the framework receives the http request 198 from the device, it invokes the preprocessor for the registered URI. The preprocessor, registered with a given pattern, has the ability to peek at the request parameters, decipher the device type, and thus return the URI appropriate for the device (192, 194,196). For example, in the case of a mobile device, the preprocessor may wish to return the URI which outputs compact HTML/WHTML.

FIG. 5 shows a flowchart of a method for providing preprocessor support for a variety of user access device types, and explains the details of what goes on inside the Web Application deployed on the Servlet Container. In step 170, the system is configured to provide a preprocessor interface for each supported device type, i.e. provide a preprocessor class for a given request pattern. In step 172 an HTTP/URL request is received from a user or a remote device. In step 174 the servlet system matches the HTTP/URL request pattern to an appropriate preprocessor, using the XML configuration file (in one embodiment the weblogic.xml file). In step 176 the system determines the device type and returns the URI for that device (e.g., converts it from HTML/WAP to HTML). In step 178 this output request string is output as a modification of the original HTTP/URL request, i.e. the request is sent to the modified URI which handles the specific device.

Configuration File (Weblogic.xml) Syntax

An administrator or developer can administer, monitor, or tune the virtual directories either through an administrative console or directly by editing the configuration file. Preprocessors are configured in the same manner as servlet mappings. The developer must provide a mapping of certain uri's to desired preprocessors. The pattern matching is done similar to the pattern matching for HTTP requests as per J2EE.

The syntax of an entry in the configuration file (for Weblogic server the weblogic.xml file is used although it will be evident that any other type of configuration file could be equally used) is as follows:

<!ELEMENT preprocessor (preprocessor-name, preprocessor-class)>

<!ELEMENT preprocessor-name (#PCDATA)>

<!ELEMENT preprocessor-class (#PCDATA)>

<!ELEMENT preprocessor-mapping (preprocessor-name, url-pattern)>

<!ELEMENT url-pattern (#PCDATA)>

The preprocessor-name element contains the canonical name of the preprocessor.

The preprocessor-class element contains the fully qualified class name of the preprocessor.

The preprocessor-mapping element defines a mapping between a preprocessor and a url pattern.

The url-pattern element contains the url pattern of the mapping, i.e. the URL request that the server receives from the user or client browser.

Preprocessor Framework

The HTTP Request Preprocessor Framework is an integral part of the servlet engine in WLS. Its main goal is to host request preprocessors that are written by third-parties. The framework acts as a container for the preprocessors. It invokes the main method preService( ) of the preprocessor registered to handle the HTTP requests.

The preprocessors are server side components hosted by the WLS servlet engine. They are invoked before the filters and servlets are called. The main goal of the preprocessor is to reroute the request to the right servlet according to some external configuration. The preprocessors may also set up the request execution by propagating the information on the request and/or session objects. The preprocessors run before the authentication occurs.

Software Interfaces

The preprocessor must implement the following interface:

public interface ServletPreprocessor {

public String preService(HttpServletRequest req);

}

The servlet container is responsible to call preService( ) method of the preprocessor that matches the URL of the request. The URL pattern matching mechanism is the same as used in the HTTP request resolution. The preprocessor can access HTTP request properties by calling the Servlet 2.3 methods of the HTTPServletRequest object. The properties accessible to the preprocessor include:

HTTP request headers,

HTTP session associated with the request, and

HTTP request parameters (populated by the query string and/or POST parameters).

Based on the information available through the HTTPServletRequest object, the preprocessor may choose to reroute the request to some other resource (JSP or servlet)in the web application. The URI that should be used to reroute to the new resource must be the return value of preService( ) method. If the return value is null, the original URI is used to resolve the request.

The preprocessors are part of the web applications. Their life cycle is the same as the servlet context of the web application. They cannot be re-deployed without re-deploying the web application. There may be multiple preprocessors configured for one web application. However, only one preprocessor will be invoked for a given request. The preprocessors cannot be “chained”. URL pattern based rules will be applied for resolving a request to an individual preprocessor.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, it will be evident that preprocessors can be incorporated into other types of http request mechanisms beyond those described, and can be used with resources other than JSP's and servlets. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for using preprocessors to respond to uniform resource indicator requests in application servers, comprising:
a web server component for receiving uniform resource indicator requests and passing said requests to the application server;
a preprocessor for modifying said requests before communicating them to a destination resource; and,
a configuration file for specifying a particular preprocessor to be mapped to said uniform resource indicator request.

2. The system of claim 1 wherein said uniform resource indicator requests are received from a user operating a web browser application.

3. The system of claim 1 wherein said uniform resource indicator requests are received from a software application.

4. The system of claim 1 wherein the configuration file is an extensible markup language file containing a plurality of entries defining the configuration of the application server environment.

5. The system of claim 4 wherein the preprocessor is specified as an entry in the extensible markup language file.

6. The system of claim 1 wherein the application server is a weblogic server and said extensible markup language file is the weblogic.xml file.

7. The system of claim 1 wherein the preprocessor is specified as an entry in the configuration file, and wherein said entry includes a uri-pattern element for specifying the pattern of the uniform resource indicator request received by the web server component.

8. A method of using virtual directories to respond to uniform resource indicator requests in application servers, comprising the steps of:
receiving uniform resource indicator requests at a web server component for communication to the application server;
identifying using a configuration file a preprocessor to be used;
communicating said request to a preprocessor for communication to a destination resource; and,
modifying said requests before communicating them to the destination resource.

9. The method of claim 8 wherein said uniform resource indicator requests are received from a user operating a web browser application.

10. The method of claim 8 wherein said uniform resource indicator requests are received from a software application.

11. The method of claim 8 wherein the configuration file is an extensible markup language file containing a plurality of entries defining the configuration of the application server environment.

12. The method of claim 11 wherein the preprocessor is specified as an entry in the extensible markup language file.

13. The method of claim 8 wherein the application server is a weblogic server and said extensible markup language file is the weblogic.xml file.

14. The method of claim 8 wherein the preprocessor is specified as an entry in the configuration file, and wherein said entry includes a uri-pattern element for specifying the pattern of the uniform resource indicator request received by the web server component.
